(19) United States
(12) Patent Application Publication
(10) Pub. No.: US 2009/0112438 A1
(43) Pub. Date: Apr. 30, 2009

(54) VEHICLE RUNNING CONTROL APPARATUS

(75) Inventors: Masatoshi Yoneyama, Aichi-ken (JP); Michihisa Shinomiya, Chiba-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignees: TOYOTA JIDOSHA KABUSHIKI KAISHA, Toyota-shi (JP); Continental Teves Corporation, Yokohama-shi (JP)

(21) Appl. No.: 12/261,690

(22) Filed: Oct. 30, 2008

(30) Foreign Application Priority Data
Oct. 31, 2007 (JP) 2007-284298

(51) Int. Cl. B60W 10/00; B60W 10/18

(52) U.S. Cl. 701/93

(57) ABSTRACT

A disclosed vehicle running control apparatus is capable of reliably detecting the operation of the brake pedal by the driver. The vehicle running control apparatus is installed in a vehicle and is capable of performing vehicle control so that the vehicle runs at a prescribed speed and controlling a brake booster during a deceleration process to generate a master cylinder pressure so that the vehicle runs at a prescribed decelerated speed. The vehicle running control apparatus includes a switching unit that is installed in the brake booster and is turned ON when a brake pedal of the vehicle is pressed; a detecting unit detecting the master cylinder pressure; and a control stopping unit stopping the vehicle control when the switching unit is turned OFF and the master cylinder pressure detected by the detecting unit is greater than a prescribed threshold value.

### CROSS-REFERENCE TO RELATED APPLICATIONS

The present application claims priority under 35 U.S.C §119 to Japanese Patent Application Publication No. 2007-284298 filed Oct. 31, 2007, the entire contents of which are hereby incorporated herein by reference.

### BACKGROUND OF THE INVENTION

1. Field of the Invention

The present invention generally relates to a vehicle running control apparatus in a vehicle capable of performing vehicle control so that the vehicle runs at a prescribed speed and controlling the brake booster of the vehicle during deceleration to generate a master cylinder pressure so that the vehicle runs at a prescribed decelerated speed. More particularly, the present invention relates to a vehicle running control apparatus capable of reliably detecting an operation of the brake pedal by the driver of the vehicle.

2. Description of the Related Art

Conventionally, there has been known a vehicle running control apparatus (called Adaptive Cruise Control (ACC) system) installed in vehicles (see, for example Patent Document 1). This vehicle running control apparatus (ACC system) controls the vehicle so that the vehicle runs at a prescribed speed and also controls the brake booster of the vehicle during deceleration by generating master cylinder pressure so that the vehicle runs at a prescribed decelerated speed.

In the operation of the ACC system, for safety reasons, the operation of the ACC system is required to be cancelled when the driver presses the brake pedal. This is because the operation of pressing the brake pedal has a higher priority.

However, in the operation of the ACC system, if it is determined whether the brake pedal is pressed based on the status (i.e., ON or OFF) of the stop lamp (brake lamp) switch, the operation of the ACC system may be disadvantageously cancelled whenever the ACC system decelerates the vehicle speed so that the vehicles runs at a prescribed decelerated speed. This is because when the brake booster of the vehicle is operated by the ACC system, the brake pedal is accordingly pulled downward in the same direction when the brake pedal is pressed by the driver, which turns ON the stop lamp (brake lamp) switch.

To overcome the problem, there has been proposed a switch (or “a micro-switch” described in Patent Document 2) that is included in the brake booster and that is turned ON only when the brake pedal is pressed downward with a prescribed pressure or more.

Patent Document 1: Japanese Patent Application Publication No. 2007-161149

Patent Document 2: Japanese Patent Application Publication No. 2003-530258

Therefore, when the “micro-switch” described in Patent Document 2 is installed and used in the ACC system disclosed in Patent Document 1 so that the operation of the ACC system is cancelled when the “micro-switch” is turned ON, the problem when the above lamp is used may be solved.

However, unfortunately, while the above stop lamp switch is designed as a double system, the circuit of the “micro-switch” is designed as a single system. Because of this feature, in a case where the relay of the “micro-switch” malfunctions and is firmly locked in its OFF position and does not turn ON, when the brake pedal is pressed downward by the driver, the operation of the ACC system is not cancelled.

From a fail-safe point of view, it is difficult to employ the “micro-switch” disclosed in Patent Document 2 in the ACC system disclosed in Patent Document 1 so that the operation of the ACC system is cancelled when the “micro-switch” is turned ON.

### SUMMARY OF THE INVENTION

The present invention is made in light of the above circumstances and may provide a vehicle running control apparatus capable of reliably detecting the operation of the brake pedal by the driver.

According to an aspect of the present invention, there is provided a vehicle running control apparatus in a vehicle capable of performing vehicle control so that the vehicle runs at a prescribed speed and controlling a brake booster of the vehicle during a deceleration process to generate a master cylinder pressure so that the vehicle runs at a prescribed decelerated speed. The vehicle running control apparatus includes a switching unit that is installed in the brake booster and that is turned ON when a brake pedal of the vehicle is pressed; a detecting unit detecting the master cylinder pressure; and a control stopping unit stopping the vehicle control when the switching unit is turned OFF and the master cylinder pressure detected by the detecting unit is greater than a prescribed threshold value.

By doing this, it becomes possible to use two separate systems of the switching unit and the detecting unit to reliably determine whether the brake pedal is pressed downward by the driver of the vehicle. As a result, even if the switching unit malfunctions by being firmly fixed to its OFF position or the like, it is possible to determine that the brake pedal is pressed downward by the driver based on the value of the master cylinder pressure and stop (cancel) the operation of the ACC system.

Preferably, in the above aspect, the prescribed threshold value is set greater than a maximum master cylinder pressure which is generated without an operation of pressing the brake pedal by the driver. This is because it is necessary to consider that the brake pedal pressure fluctuates every second when the brake booster is being controlled to decelerate the vehicle speed as the ACC operation.

### BRIEF DESCRIPTION OF DRAWINGS

Other objects, features, and advantages of the present invention will become more apparent from the following description when read in conjunction with the accompanying drawings, in which:

FIG. 1 is a schematic drawing showing a configuration of a vehicle running control apparatus according to an embodiment of the present invention; and

FIG. 2 is a flowchart showing a process of canceling the operation of an ACC (Adaptive Cruise Control) system according to an embodiment of the present invention.

### DETAILED DESCRIPTION OF THE PREFERRED EMBODIMENT

In the following, an exemplary embodiment of the present invention is described with reference to the accompanying drawings. It should be noted that the basic concept, the schematic hardware configuration, the operating principle, and the basic controlling method of the ACC (Adaptive Cruise Control) system are known to a person skilled in the art. Therefore, the detailed descriptions thereof are omitted herein.

### Embodiment

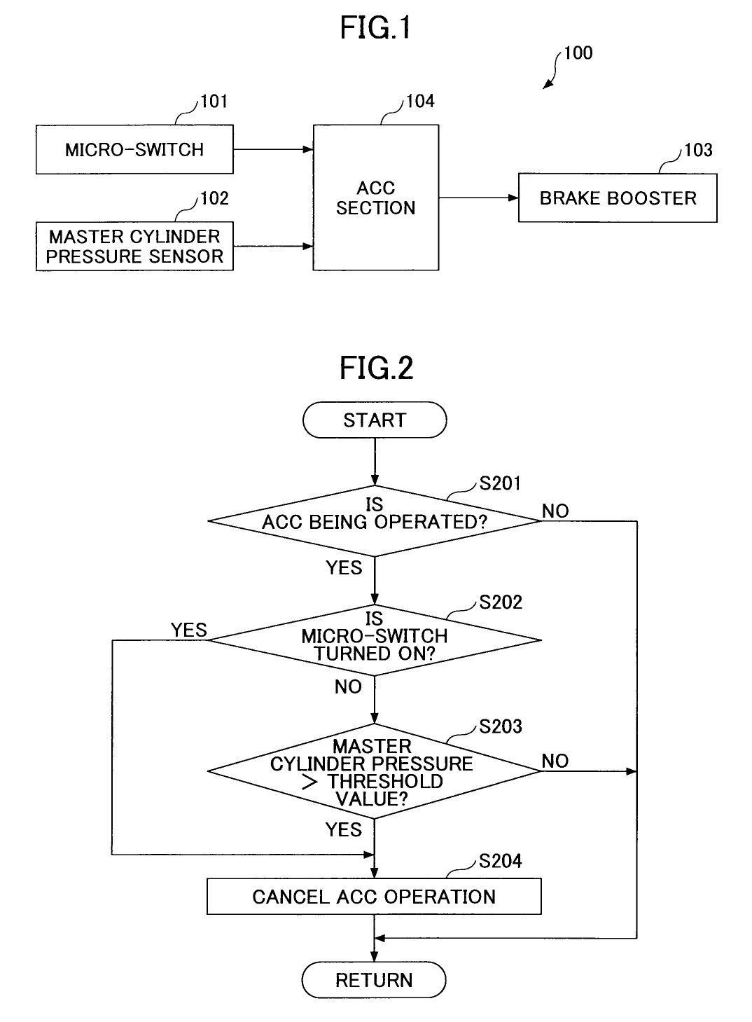

FIG. 1 schematically shows a vehicle running control apparatus 100 in a vehicle according to an embodiment of the present invention.

As shown in FIG. 1, the vehicle running control apparatus 100 includes a micro-switch 101, a master cylinder pressure sensor 102, a brake booster 103, and an ACC (Adaptive Cruise Control) section 104.

The micro-switch 101 is provided in the brake booster 103 and is turned ON when the brake pedal of the vehicle is pressed with a prescribed pressure or more by the driver of the vehicle.

The master cylinder pressure sensor 102 is provided in a master cylinder unit (not shown) and detects the master cylinder pressure. It should be noted that the master cylinder pressure sensor 102 may be a sensor used from another vehicle system such as a vehicle control system called a “VSC (Vehicle Stability Control (registered trademark)) system” which prevents the vehicle from spinning or drifting.

The brake booster 103 increases the master cylinder pressure by supplying pressure to the master cylinder (not shown) when the brake pedal is pressed by the driver. Further, in a case where the ACC system is being operated, when the brake booster 103 receives an instruction from the ACC section 104 to generate the master cylinder pressure to decelerate the vehicle speed, the brake booster 103 serves as an active brake booster by increasing the master cylinder pressure regardless of the operation of the brake pedal by the driver.

The ACC section 104 may be an ECU (Electronic Control Unit), and, when the ACC system is being operated, transmits an instruction to the brake booster 103 to increase the master cylinder pressure regardless of the operation of the brake pedal by the driver when it is necessary to decelerate the vehicle speed so that the vehicle runs at a prescribed speed (so that, for example, the inter-vehicle distance to the preceding vehicle is within a prescribed range).

In this embodiment, in a case where the ACC system is being operated, when the ACC section 104 determines that the brake pedal is pressed by the driver based on the output from the micro-switch 101 and the output from the master cylinder pressure sensor 102, the ACC section 104 stops (cancels) the operation of the ACC system.

The process of this cancel operation is described with reference to the flowchart in FIG. 2.

First, the ACC section 104 determines whether the ACC system is being operated (step S201).

When it is determined that the ACC system is being operated (YES in step S201), the ACC section 104 determines whether the micro-switch 101 is being turned ON (step S202).

When it is determined that the micro-switch 101 is being turned ON (YES in step S202), the ACC section 104 determines that the brake pedal is pressed by the driver and promptly stops (cancels) the operation of the ACC system (Step S204).

On the other hand, when it is determined that the micro-switch 101 is not turned ON (NO in step S202), the ACC section 104 determines whether the master cylinder pressure detected by the master cylinder pressure sensor 102 is greater than a prescribed threshold value (step S203).

Herein, it should be noted that even when the brake booster 103 generates the master cylinder pressure due to a cause other than the operation of the brake pedal by the driver, the driver may further press the brake pedal. Because of this possibility, the prescribed threshold value to be set is greater than the sum of the maximum master cylinder pressure generated without the operation of pressing the brake pedal by the driver and at least the pressure caused by the operation of pressing the brake pedal by the driver.

Referring back to FIG. 2, when it is determined that the master cylinder pressure detected by the master cylinder pressure sensor 102 is greater than the prescribed threshold value (YES in step S203), the ACC section 104 determines that the brake pedal is pressed by the driver and promptly stops (cancels) the operation of the ACC system (Step S204).

As described above, in the vehicle running control apparatus according the embodiment of the present invention, it becomes possible to use two separate systems of the switching unit and the detecting unit to determine whether the brake pedal is pressed downward by the driver of the vehicle. As a result, even if the switching unit malfunctions by being firmly fixed to its OFF position or the like, it is possible to determine that the brake pedal is pressed downward by the driver based on the value of the master cylinder pressure and stop (cancel) the operation of the ACC system.

The present invention may be applied to an ACC system having an adaptive brake booster regardless of, for example, the kind of power source, the kind of fuel, the exterior design, the weight, the sizes, and the driving performance of the vehicle.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teachings herein set forth.

What is claimed is:

1. A vehicle running control apparatus that is installed in a vehicle and that is capable of performing vehicle control so that the vehicle runs at a prescribed speed and controlling a brake booster of the vehicle during a deceleration process of the vehicle to generate a master cylinder pressure so that the vehicle runs at a prescribed decelerated speed, the vehicle running control apparatus comprising:
a switching unit that is installed in the brake booster and that is turned ON when a brake pedal of the vehicle is pressed;
a detecting unit detecting the master cylinder pressure; and
a control stopping unit stopping the vehicle control when the switching unit is turned OFF and the master cylinder pressure detected by the detecting unit is greater than a prescribed threshold value.

2. The vehicle running control apparatus according to claim 1, wherein
the prescribed threshold value is set greater than a maximum master cylinder pressure generated without an operation of pressing the brake pedal by a driver of the vehicle.
